(19) United States
(12) Patent Application Publication
(10) Pub. No.: US 2003/0097285 A1
(43) Pub. Date: May 22, 2003

(54) Method of receiving a booking request from a user, making the booking and generating a travel confirmation document

(76) Inventor: Mohamed Ghaniem, Houghton Estate (ZA)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/299,390

(22) Filed: Nov. 19, 2002

(30) Foreign Application Priority Data
Nov. 20, 2001 (ZA) 2001/9557

(51) Int. Cl. G06F 17/60

(52) U.S. Cl. 705/5

(57) ABSTRACT

A method of receiving a booking request from a user, making the booking and generating a travel confirmation document includes providing a prospective traveller with travel information. A booking request is received from the traveller or their agent and before a travel document is issued, a photograph of the traveller is taken and printed on the travel document. A digital image of the travel document is stored in a database and forwarded to third party product and service providers, such as an airline.

### BACKGROUND OF THE INVENTION

This invention relates to a method of receiving a booking request from a user, making the booking and generating a travel confirmation document. The present invention is particularly suited for the travel industry whose current method of operation is cumbersome and not very user friendly.

A prospective traveler wishing to book their trip typically approaches a travel agent who books airline tickets, hotel accommodation, car hire and any other necessary travel related services or products.

In the case of airline tickets, once the booking is confirmed and payment is received by the travel agent from their customer, an airline ticket is printed carrying the name of the customer and details of the flight or flights the customer is booked on.

Hotel accommodation is confirmed usually merely by a fax from the hotel confirming the booking and sometimes requesting a deposit to hold the booking.

Of course, with the advent of the Internet age, prospective travelers are also able to log onto the website of a hotel, for example, and make a booking by inputting their personal details. The confirmation of their booking is then typically downloaded to them or forwarded to them by e-mail.

All of these systems have a number of drawbacks.

For example, there is currently no integrated travel document which can be used as an airline ticket, a boarding pass for the airline, a confirmation of a hotel booking and a confirmation of a car booking, for example.

Also, current tickets for the airline do not carry much information about the ticket holder and therefore do not provide much security in this regard.

It is therefore an object of the present invention to address these and other drawbacks of the current travel booking system.

### SUMMARY OF THE INVENTION

According to the present invention there is provided a method of receiving a booking request from a user, making the booking and generating a travel confirmation document, the method comprises the steps of:

receiving, at a server, a request from a user, the request being for a travel related product and/or service;

providing information about the travel related product and/or service to the user via a communication network;

receiving confirmation from the user that they wish to make a booking for the travel related product and/or service;

generating a travel confirmation document for the user;

storing data relating to the travel confirmation document; and

forwarding data relating to the travel confirmation document to the third party product and/or service provider.

The method may comprise the step of forwarding the request from the server to a third party product and/or service provider, and receiving information in response to the request from the third party.

Preferably, a photograph is taken of a prospective traveler who will be using the travel confirmation document, which photograph is incorporated into the travel confirmation document.

The user may be issued with a record number, wherein the travel confirmation document is only generated upon receipt of the record number at the server.

Preferably, the travel confirmation document is generated at one of a plurality of remote locations where the prospective traveler has input the record number into a document generating device.

The document generating device may be a thermal printer which prints an erasable thermal card.

The data forwarded to the third party product and/or service provider enables software running on a computer of the third party to produce an image of the travel confirmation document, thereby enabling the third party to compare the image with a physical travel confirmation document presented to them before providing the product and/or service to the document holder.

Before the travel confirmation document is generated, a scan of at least one of the prospective traveler's face, eye or fingerprint may be taken, transmitted to the server and information regarding the scan is stored in an associated database.

Before providing the prospective traveler with a product and/or service, the third party may take a second scan of at least one of the prospective traveler's face, eye or fingerprint which is transmitted to the server and compared with the information stored in the associated database.

The invention extends to a machine readable medium comprising instructions, which when executed by a machine, cause the machine to perform the method described above.

### DESCRIPTION OF THE DRAWINGS

FIG. 1 is a block diagram of an embodiment of the system of the present invention;

FIG. 2 illustrates a travel confirmation document according to the present invention; and

FIG. 3 is a flowchart illustrating the steps carried out by the software running on the central server.

### DESCRIPTION OF EMBODIMENTS

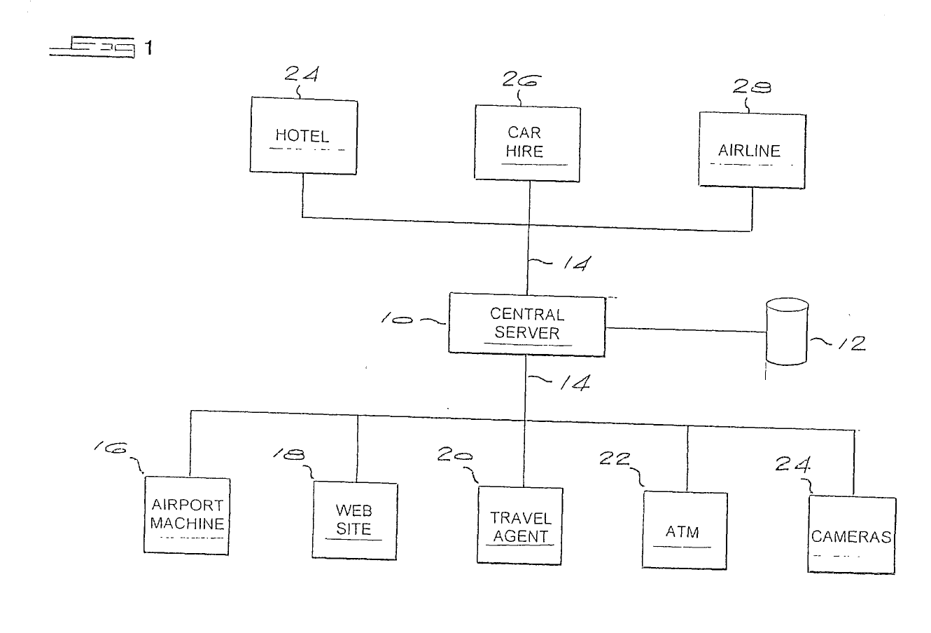

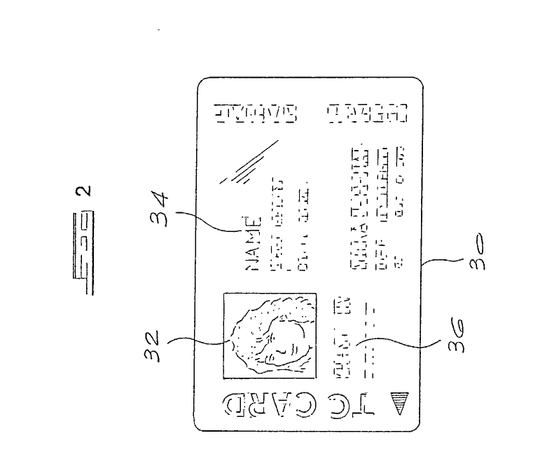

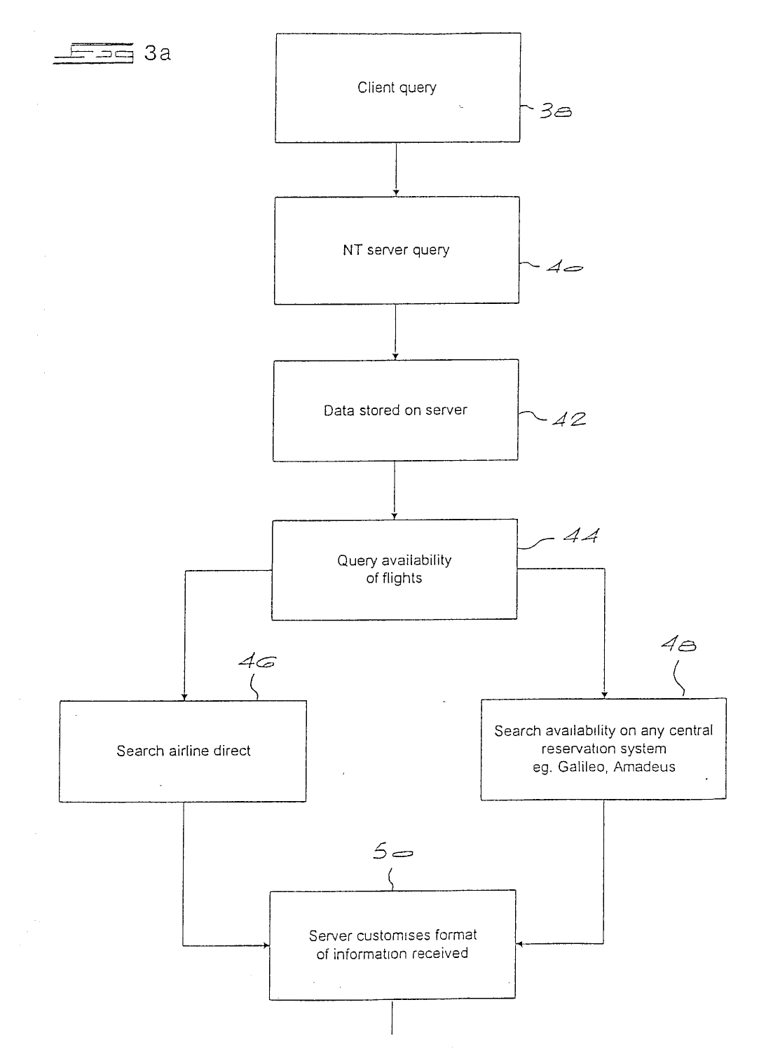

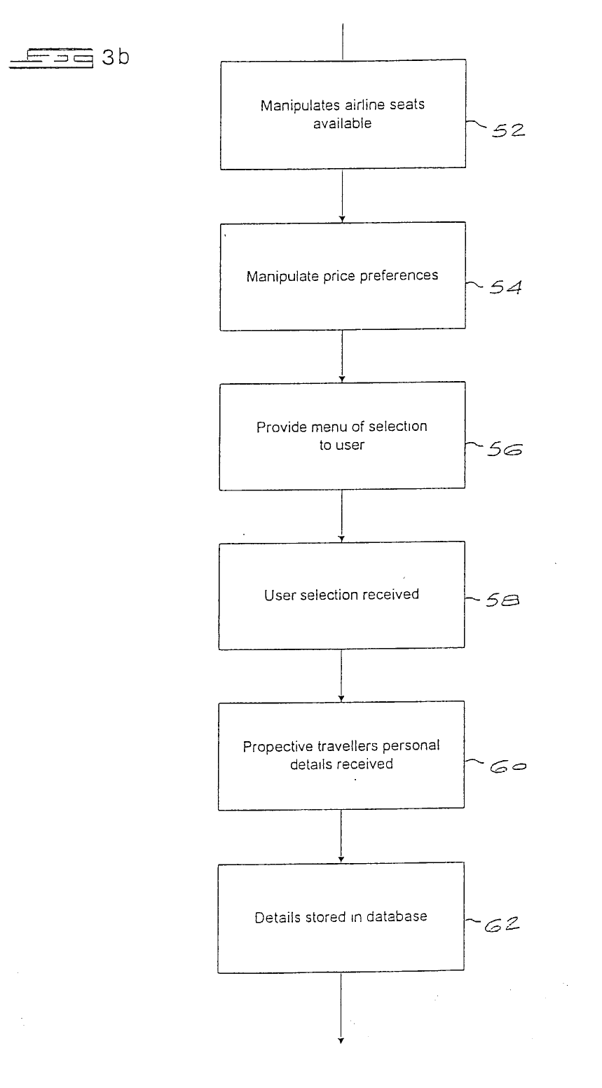

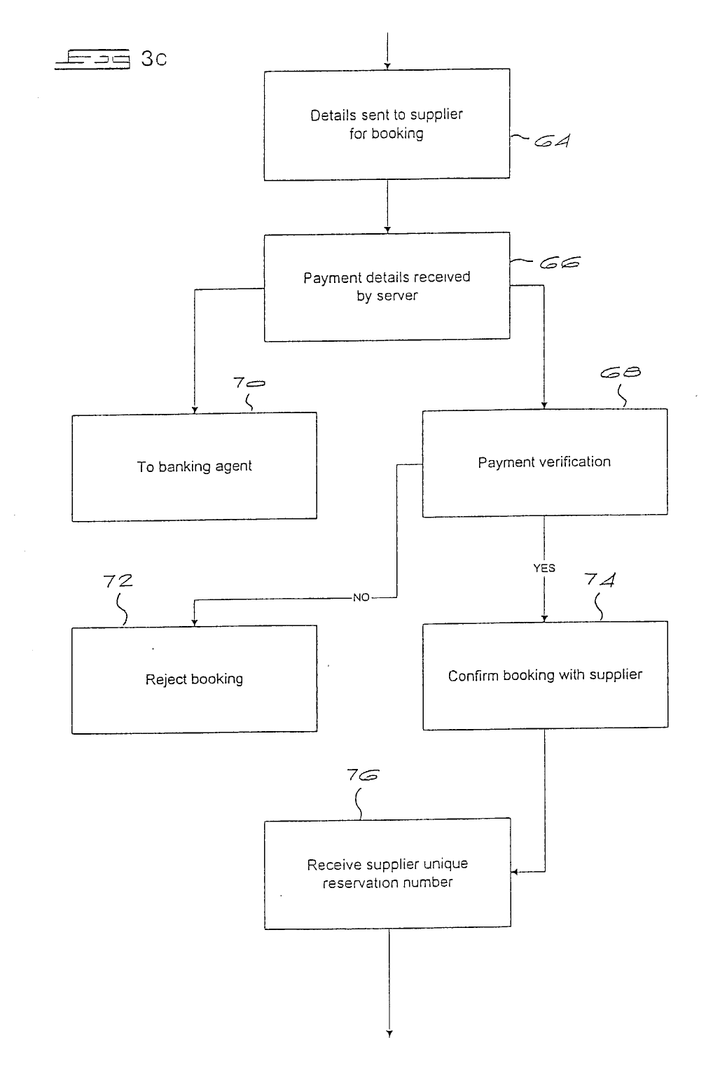

Referring to FIG. 1, the heart of the present invention is a central server 10 with an associated database 12.

The central server 10 is connected by one or more communications networks 14 to various locations where travel related products and/or services are sold to prospective travelers.

In the illustrated embodiment, the prospective travelers are enabled to purchase the travel-related products and/or services at an airport machine 16, via a web site 18, at travel agents 20 or using an ATM 22. It will be appreciated that the present invention could be implemented simultaneously at one or more of the locations and could also be implemented at other locations not shown.

A camera 24 is located either separately from the location and/or a camera is installed at each location.

The other side of the central server 10 is connected via communication network 14 to a hotel 24, a car hire outlet 26 and to an airline 28. Once again, it will be appreciated that these are merely examples of travel-related products and/or services to which the central server 10 can be connected.

Furthermore, in practice, the present invention will probably be connected to a plurality of hotels, a plurality of airlines and a plurality of car hire outlets.

The central server 10 manages the database 12 and provides the necessary user interfaces.

It will be appreciated that in certain cases the user will be someone, such as a travel agent, assisting the prospective traveler while in other cases the user will be the prospective traveller themselves, such as in an Internet enabled example. Thus, a user may be a member of the general public, a travel agent, the airlines or other travel service providers.

A user requesting to book a flight will use software running on a computer at one of the remote locations (16, 18, 20, 22) and will be presented with a graphical user interface allowing them to search for their desired travel related product and/or service.

Thus, they will be presented with a menu of options, one of the options being “flight options”.

These will typically be selected using a mouse, and after clicking on this option the user is presented with a search screen allowing them to input data to allow a search to be conducted for the flight they desire.

Typical input data might be a selection of destinations, class and dates.

Of course, the user will be required to input the details of the prospective traveler which are sent to the central sever 10 and stored in the database 12. If the prospective traveler has used the system before, the details are stored together in their profile which can be built into specific requests for preferences noted for future reference.

Once the user has input data, their request is transmitted via the communications network 14 through the central server. The central server unpacks the data received and repack it in the required proprietary format to be passed onto the third party vendor. In the case of an airline, the data is passed to the airline in a format recognizable by the airline system.

The airline system returns a list of available flights and costs to the central server 10, which unpacks the data and reformats it for transmission to the user.

The information is displayed to the user in a user-friendly way allowing them to easily select which flight they wish to travel on.

Once the potential traveler has selected a flight, the user transmits a confirmation via the communications network 14 to the central server 10 that they wish to make a booking.

This request is once again configured into a request to the relevant airline to reserve the tickets.

The third party vendor generates a passenger reservation number (PNR) which is transmitted to the central server 10 and stored in the associated database 12.

Thus, in order to effect their booking, messages are sent to and fro between the systems and various reference numbers are generated. This will be described in more detail below.

If the prospective traveler now wishes to make a hotel booking, for example, a similar process is followed to connect with the systems of a hotel 24.

Once the user is finished making bookings, all of the information stored on the database 12 is used to generate a travel confirmation document in the form of a travel card 30.

The travel card 30 includes a photograph 32 of the traveler together with their personal details 34 and details of all the travel related services and/or products they have purchased 36. It will be appreciated that the travel card could include a variety of other information. For example, in the prototype of the present invention, the travel card included financial information detailing how the prospective traveller paid for the products and/or services they purchased.

In order to obtain a photograph of the traveler 32, cameras 24 are positioned at either the locations (16, 18, 20, 22) or at other independent locations.

Where the cameras 24 are associated with the locations (16, 18, 20, 22), the travelers photograph can be taken immediately upon booking. This photograph is then used to print the travel card 30 and the image is also transmitted to the central server 10 to be stored in the database 12.

In the prototype of the present invention, the travel card 30 was implemented using an erasable thermal card together with a thermal printer.

In the case where a camera 24 and/or printer are not located at the location (16, 18, 20, 22), the traveler is provided with a unique code generated by the central server 10.

The prospective traveler is then able to approach a camera with accompanying printer and terminal and is now able to type in their unique code which is transmitted to the central server 10 for verification.

Upon verification, the central server transmits a message back to the camera 24 and associated terminal and printer. The prospective traveler then sits in front of the camera and has their photograph taken which is then used to print the thermal travel card 30.

The data relating to the travel card is stored on the central database 12 and is also transmitted to the systems where the prospective traveler has confirmed bookings, such as the system of the hotel 24, the car hire 26 and airline 28.

The travel card 30 with all of the prospective travelers bookings thereon is now the travelers sole ticket used to obtain their travel related products and/or services.

For example, when boarding the airline, the traveler presents their travel card and the airline attendant calls up a copy of the travel card from their associated database. If the two cards compare correctly, the traveler is allowed to board the airplane.

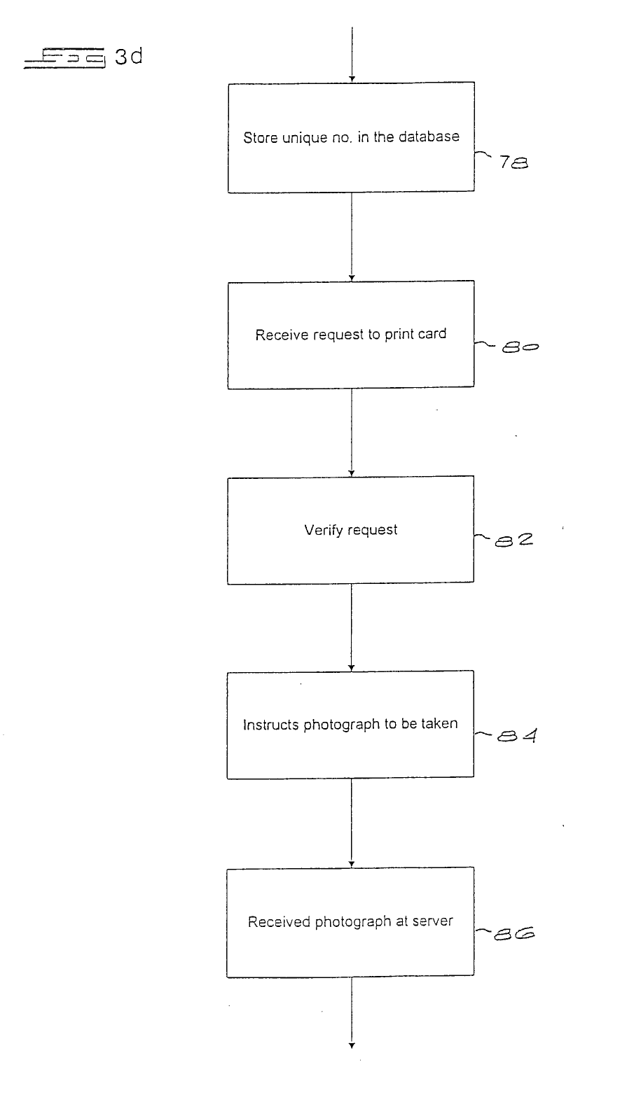

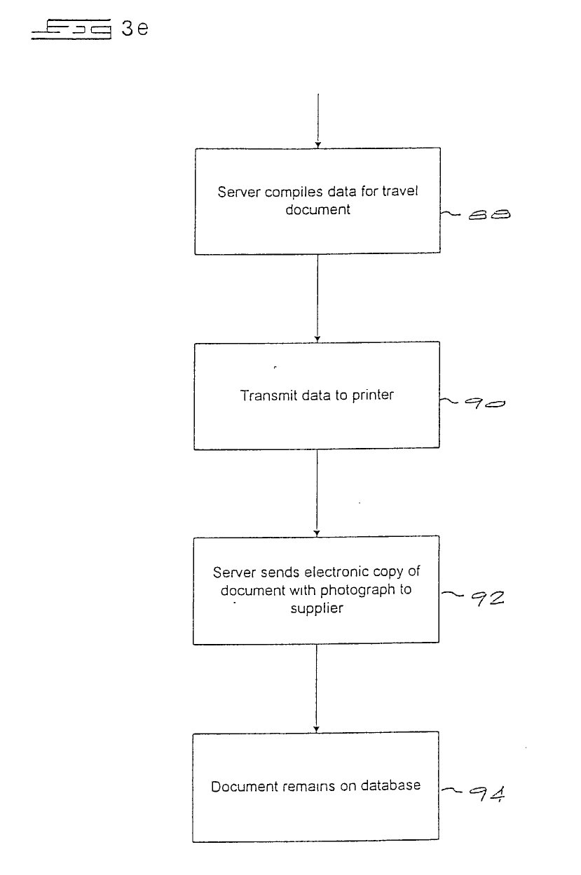

FIG. 3 is a block diagram illustrating the method steps carried out by the central server 10 in more detail.

The prototype server was implemented using an NT server running Visual Basic and Microsoft™ access.

Referring to FIG. 3, a client query 38 (or user query) is received at the server which initiates a query on the server itself in step 40.

Immediately upon receiving a request, a client record number is automatically generated and stored in the database together with details of the query 42. All future information is stored under the client record number for future use. This client record number is the key to the prospective travellers personal details and booking history for the system administrators.

As described above, the client's query will be for one of the third party's travel related product and/or services. Thus, the query will include the details of the product and/or services required.

For example, where the query is for the booking of a hotel room, the query will include the required dates, number of adults and children for the room, a pass range, and a range of locations.

All of this information is in addition to the prospective traveller's personal contact details including:

Name

Surname

Address

Telephone Number

Fax Number

E-mail Address.

The information is stored in the database under the client's record number.

Using the example of purchasing airline tickets, the software running on the server puts together a message to query the airlines in step 44.

The query will typically contain the parameters of the request for particular flights and will also include the client's record number as a reference number. The request can either be routed directly to the airline's system in step 46 or via any central reservation system such as Galileo™ or a Amadeus™ 48.

In a case where a user has selected a destination and has not specified a particular airline, the server will send the query to a few airlines who fly the particular route in order to obtain the best price available.

All communication takes place via ISDN lines or via the Internet, both of which are linked to the server 10.

The results of the queries are received back at the server and stored in the database under the client record number.

Typically, each supplier generates its own code which is associated with the information request and this is also stored in the database.

The server customizes the format the information received in step 50 and then manipulates the airline seats available and the price preferences in steps 52 and 54 respectively, before providing this to the client via a menu in step 56.

The reason for the manipulation of the airline seats available and price preferences are that the airline typically returns a number of different classes of seats at a number of different prices. However, the server managers will only return a select few of these to the client based on their own preferences, such as a particular class of seats.

Once these have been transmitted to the user, the server waits for a booking confirmation.

If a user selection is received 58, this constitutes a booking on the prospective traveller's behalf.

If the prospective traveller has not input their personal details previously, their details are input at this point and are received 60 at the server. These details are then stored, step 62, in the database 12.

The information is sent to the third party supplier for bookings 64.

The server prompts the user to input payment information (not shown), and payment details 66 received by the server. Obviously, these payment details could be included with the client's personal details in step 60.

The server requests payment verification 68 using known processes whereby the server connects to a banking system and passes the payment details to the banking system 70.

If the payment is rejected, the booking is rejected 72 and messages are sent to the client and to the third party provider to release the booking. If the payment is approved, the server issues a message to the third party supplier 74 who confirms the booking and returns a unique reservation number 76.

The unique number is stored in the database in step 78, under the client record number.

At sometime in the future, a request will be received 80 at the server to generate the travel confirmation document.

As mentioned above, in the prototype, the travel documents took the form of an erasable thermal card printed using a thermal printer.

If a printer is available at the place where the traveler made their booking, they will usually simultaneously request their travel documents.

The request is verified by the server 82 which questions the person requesting that the document be printed. The questions relate to details about the booking such as where the booking was made and details of the prospective traveller such as their ID number. If the request is verified, the software instructs the remote terminal to take a photograph of the person requesting the travel document 84.

Once the photograph is taken, data representing the photograph is transmitted and received at the central server in step 80. The photograph is stored in the database.

The server compiles the data for the travel document in step 88, and transmits this to the printer 90 via the communications network 14.

The server also sends a copy of the document to each of the third party suppliers in step 92. The third party suppliers store the data representing the document on their systems for comparison with the printed document at a later stage.

The document is also stored on the database in step 94.

It will be appreciated that this means that a profile of the client, including their booking history can be built up.

Where a user wishes to change a booking, a similar procedure is followed to that of the above where the user will access their travel document, cancel a particular booking and request information relating to an alternative booking. The travel document is then updated and is reprinted.

For additional security, a biometrics system can be incorporated into the system of the present invention. Biometrics systems use photographs, a scan of the eye, and fingerprints to more positively identify the individual. Such biometrics systems are currently known.

Thus, before the travel document is printed, in addition to a photograph of the person requesting the document, a scan of at least one of the person's eye/face and their fingerprint can be taken. Obviously, in order to implement this, a biometrics unit needs to be associated with the printer.

This data can then be stored for two primary reasons. Firstly, if the person loses the travel document and needs the document to be reprinted, this will only be provided to them if another biometrics device positively identifies them. This will typically mean that at least one of a scan of the persons face, eye or fingerprint will be required to match the stored scan data. Obviously, for high security, all the aspects can be incorporated simultaneously.

The second reason to implement the biometrics aspect of the invention is that it could be used to further check that the person travelling is in fact the person who printed the travel document. Thus, before boarding an aeroplane, for example, the traveller would be required to take a further biometrics examination which results are compared with the biometrics information stored at the time the ticket was issued. Only if the results of this examination were positive, would the traveller be allowed to board the aeroplane.

In order to implement this aspect of the invention, referring to FIG. 1, the biometrics, information is transmitted over the communication network 14 to the central server 10 and is stored in the associated database 12 for later use.

In either of the above two scenarios, when a ticket is being reissued or during a security check, the information stored in the database 12 is re-accessed for use in the comparison.

In addition, in countries where biometrics information regarding individuals is stored by the State, the by biometrics information can be transmitted from the central server 10 to a State owned server. This allows the State to have knowledge of all persons travelling and to keep track of particular individuals who may be on a watch list for involvement in illicit activities.

Unlike the present airline tickets which are discarded after use, the traveler keeps the travel card which is then used as their boarding pass.

For the first time, a picture of the traveler is included on their ticket and boarding pass which has obvious security advantages.

When the traveler checks into the hotel, the clerk at the desk again calls up a copy of the travel card and compares it to the travel card presented to them.

It will be appreciated that because the traveler also has a unique code which they use to generate the travel card, if the travel card is lost, the user can approach a camera 24 and associated terminal wherever they may be and get the travel card reissued.

It will also be appreciated that where the traveler as a large number of bookings, more than one travel card may be issued to them which would almost be like consecutive pages in a book.

I claim:

1. A method of receiving a booking request from a user, making the booking and generating a travel confirmation document, the method comprises the steps of:
receiving, at a server, a request from a user, the request being for a travel related product and/or service;
providing information about the travel related product and/or service to the user via a communication network;
receiving confirmation from the user that they wish to make a booking for the travel related product and/or service;
generating a travel confirmation document for the user;
storing data relating to the travel confirmation document; and
forwarding data relating to the travel confirmation document to the third party product and/or service provider.

2. A method according to claim 1 further comprising the step of forwarding the request from the server to a third party product and/or service provider, and receiving information in response to the request from the third party service provider.

3. A method according to claim 1 wherein a photograph is taken of a prospective traveler who will be using the travel confirmation document, which photograph is incorporated into the travel confirmation document.

4. A method according to claim 1 wherein the user is issued with a record number, wherein the travel confirmation document is only generated upon receipt of the record number at the server.

5. A method according to claim 4 wherein the travel confirmation document is generated at one of a plurality of remote locations where the prospective traveler has input the record number into a document generating device.

6. A method according to claim 5 wherein the document generating device is a thermal printer which prints an erasable thermal card.

7. A method according to claim 1 wherein the data forwarded to the third party product and/or service provider enables software running on a computer of the third party to produce an image of the travel confirmation document, thereby enabling the third party to compare the image with a physical travel confirmation document presented to them before providing the product and/or service to the document holder.

8. A method according to claim 1 wherein before the travel confirmation document is generated, a scan of at least one of the prospective traveler's face, eye or fingerprint is taken, transmitted to the server and information regarding the scan is stored in an associated database.

9. A method according to claim 8 wherein before providing the prospective traveler with a product and/or service, the third party takes a second scan of at least one of the prospective traveler's face, eye or fingerprint which is transmitted to the server and compared with the information stored in the associated database.

10. A machine readable medium comprising instructions, which when executed by a machine, cause the machine to perform the method steps in any one of claims 1 to 9.
